(19) United States
(12) Patent Application Publication
(10) Pub. No.: US 2013/0015389 A1
(43) Pub. Date: Jan. 17, 2013

(54) FIRE RESISTANT FOAM INSULATION COMPOSITIONS

(71) Applicant: Francisco Jose Torres-Aranda, JR., Hazleton, PA (US)

(72) Inventor: Francisco Jose Torres-Aranda, JR., Hazleton, PA (US)

(21) Appl. No.: 13/181,606

(22) Filed: Jul. 13, 2011

(51) Int. Cl. C08L 75/04; C08J 9/35; C08K 7/16; E04B 1/78; C08L 75/06

(52) U.S. Cl. 252/62

(57) ABSTRACT

This invention relates to polyurethane foam insulation materials comprising cenospheres, a coal combustion waste by-product, a poly-isocyanate and petroleum and/or vegetable based polyols and/or post-industrial or post-consumer recycled polyester to produce polymeric foam insulation products useful in building materials and component products. The percentage of industrial waste product, recycled materials and sustainable vegetable based components used in the formulations support make this a “green” composition.

The present invention relates to improved “green” fire resistant insulation compositions and articles formed therefrom.

### BACKGROUND OF THE INVENTION

The present invention relates to fire resistant rigid and flexible foam insulation products resulting from the mixing of poly-isocyanate, a polyol and a filler comprised of hollow microspheres that are separated from raw coal combustion waste ash or “fly ash”, a soluble alkali metal silicate, a blowing agent and a catalyst. Preferably, the present invention relates to fire resistant, “green”, rigid or flexible foam insulation products resulting from the mixing of cyanide-free poly-isocyanate, vegetable oil based polyol such as hydroxylated soy oil based polyol that may contain recycled thermoplastic polyester a filler comprised of hollow microspheres such as cenospheres which are separated from raw coal combustion waste ash or “fly ash”, a sodium silicate bonding agent, a blowing agent and a catalyst. Upon exposure to fire sufficient to burn the organic components of the polyurethane foam insulation, a non-combustible rigid ceramic structure remains occupying the same space as original foam insulation.

Polyurethane and other polymer-based insulation products in a number of forms are well known in the art. As will be described, however, none of the prior art includes the use of both coal combustion waste by-products, a soluble alkali metal silicate and a polyol which is preferably a vegetable oil based and/or recycled polyester based polyol that result in a “green” fire resistant insulation foam.

Self, U.S. Pat. No. 4,011,195, discloses compositions comprising an unsaturated polyester resin syrup and aqueous sodium silicate, also containing various fillers, including flyash to form sheet or laminate products. It is stated that the sodium silicate extends the resin and that, when finished structures containing the resin are exposed to flame, the organic content of is burned forming a refractory ceramic residue that resists further thermal deterioration. In a preferred embodiment of the invention, the unsaturated polyester resin syrup contains powdered hydrated alumina and the aqueous alkali metal silicate also contains hydrated alumina. The amount of unsaturated polyester resin syrup is minimized so that the final product possesses a low fuel content. When exposed to fire, the cured products resist temperature increases initially because of the thermal dehydration of the hydrated alumina and thereafter by vitrification of the hybrid silica. Compositions which include hydrated alumina have a lowered smoke generating characteristic. There is no disclosure of polyurethane or foamed polyurethane products.

Stubby, U.S. Pat. No. 4,661,533, discloses a polyurethane modified polyisocyanate closed cell foam that contains flyash as an ingredient to reduce friability. While the disclosed foam compositions contain flyash, there is no disclosure of the use of cenospheres and there is no disclosure of a soluble alkali metal silicate. There is further neither disclosure nor suggestion of the use of soy based or soy/recycled polyester based polyols. There is also no disclosure of a non-combustible rigid ceramic remaining after combustion of the foam.

Glorioso et al., U.S. RE 37,095, discloses a method of forming isocyanate/polyol thermosetting foams wherein a catalyst is added to the extruder/reactor either in the last extruder barrel, or at the extruder head. It is disclosed that the method permits an enhanced quantity of filler to be added to the mixture. While flyash is disclosed among named fillers, the preferred fillers are aluminum trihydrate, perlite, ammonium phosphate or calcium carbonate, alone or in combination with carbon black. While the disclosed foam compositions contain flyash, there is no disclosure of the use of cenospheres and there is no disclosure of a soluble alkali metal silicate. There is further neither disclosure nor suggestion of the use of soy based or soy/recycled polyester based polyols. There is also no disclosure of a non-combustible rigid ceramic remaining after combustion of the foam.

Brenot, et al., U.S. Pat. No. 6,017,595, discloses compositions for preparing structural building materials comprising prepared or reprocessed waste material such as lime from a water treatment plant, in combination with a reinforcing material and a polymeric material, such as polyurethane. There is no disclosure of the use of coal combustion waste or vegetable-based polyols. There is no disclosure of compositions containing flyash, there is no disclosure of the use of cenospheres and there is no disclosure of a soluble alkali metal silicate. There is further neither disclosure nor suggestion of the use of soy based or soy/recycled polyester based polyols. There is also no disclosure of a non-combustible rigid ceramic remaining after combustion of the foam.

Shukla, et al., U.S. Pat. No. 6,506,819, discloses particulate compositions comprising a polyester resin, a plasticizer and a plurality of cenospheres. There is no disclosure of a soluble alkali metal silicate. There is also no disclosure of a non-combustible rigid ceramic remaining after combustion of the foam. There is further neither disclosure nor suggestion of the use of soy based or soy/recycled polyester based polyols. The compositions are used to make functionally gradient material, including insulation. The cenospheres are nonhomogeneously distributed in the resin composition.

Mashburn, et al., Published U.S. Patent Application No. 20070275227, teaches carpet backing compositions comprising polyol/isocyanate foams wherein the polyol is disclosed as being a hydroxylated vegetable oil including hydroxylated soy oils. It is stated that the preferred polyol oils are hydroxylated vegetable oils. The compositions may contain a filler including, inter alfa, flyash. There is no disclosure of a soluble alkali metal silicate and cenospheres. There is also no disclosure of a non-combustible rigid ceramic remaining after combustion of the foam.

Herrington, et al., US Patent Application Publication 2011/0086934 discloses composite materials and methods for their preparation. The composite materials include polyurethane made from the reaction of an isocyanate and a mixture of polyols, and coal ash (e.g., fly ash). The mixture of polyols comprises at least two polyols including a high hydroxyl number polyol having a hydroxyl number greater than 250 and comprising from about 1% to about 25% by weight of the total polyol content used to form the polyurethane, and a low hydroxyl number polyol having a hydroxyl number of 250 or lower. The coal ash is present in amounts from about 40% to about 90% by weight of the composite material. Also described is a method of preparing a composite material, including mixing an isocyanate, a mixture of at least two polyols, coal ash (e.g., fly ash), and a catalyst. While the disclosed foam compositions contain flyash, there is no disclosure of the use of cenospheres and there is no disclosure of a soluble alkali metal silicate. There is further neither disclosure nor suggestion of the use of soy based or soy/recycled polyester based polyols. There is also no disclosure of a non-combustible rigid ceramic remaining after combustion of the foam.

Sterling, US Patent Application Publication 2010/0053974 discloses a heat-resistant cementitious composition comprising a binder comprising potassium silicate, and at least one filler material, the filler material substantially non-reactive with said potassium silicate; wherein the cementitious composition, in the presence of water, has a ramp flow value of less than about 10 in the substantial absence of vibration; and wherein the cementitious composition, in the presence of water, has both thixotropic flow properties and pseudoplastic flow properties. Also provided are lamp assemblies employing such cementitious compositions. Some suitable materials for use as coarse filler particles include microspheres, examples of which are known to the skilled practitioner. Examples may include cenospheres, hollow microspheres, and FILLITE (trademark of Trelleborg Fillite Inc. Suwanee Ga. for ceramic spheres); or the like.

While the disclosed compositions contain cenospheres and disclosure of a soluble alkali metal silicate. The disclosed compositions do not disclose poly urethane foams. There is further neither disclosure nor suggestion of the use of soy based or soy/recycled polyester based polyols. There is also no disclosure of a non-combustible rigid ceramic remaining after combustion of a foam.

Godeke, et al., US Patent Application Publication 2002/0128142 Discloses a lightweight substance molded body made of a lightweight aggregate and a sintering auxiliary agent, wherein said molded body consist of a sintering product containing 60-95 wt. % lightweight aggregate with 40-5 wt. % water-soluble alkali silicate. Molded body from a lightweight substance formed from a lightweight aggregate and a sintering auxiliary, characterized by the fact that the lightweight substance is a sintered product obtained by mixing of 60 to 95 wt. % of a lightweight aggregate, chosen from perlites, expanded clay, expanded glass, vermiculites, cenospheres and kieselguhr and/or their mixtures with 40 to 5 wt. % of an aqueous alkali silicate solution, in which the lightweight aggregate is bonded in a network fashion exclusively at the contact sites to obtain its essential properties. A molded body according to at least one of the claims 1 to 3, is characterized by the fact that the sintered product is formed from 93 to 80 wt. % of lightweight aggregate and 7 to 20 wt. % of water-soluble alkali silicates. Process for production of a molded body according to at least one of the claims 1 to 5, characterized by the fact that the lightweight aggregate and the binder are subjected to a shaping process after mixing and sintered at 400.degree. C. to 1000.degree. C. over a period from 0.1 h to 5 h.

While the disclosed compositions contain cenospheres and disclosure of a soluble alkali metal silicate. The disclosed compositions do not disclose poly urethane foams. There is further neither disclosure nor suggestion of the use of soy based or soy/recycled polyester based polyols. There is also no disclosure of a non-combustible rigid ceramic remaining after combustion of a foam.

While the disclosed compositions contain various components of the present invention, there is no disclosure of urethane foams containing cenospheres or of a soluble alkali metal silicate. There is further neither disclosure nor suggestion of the use of soy based or soy/recycled polyester based polyols.

None of the prior art mentioned teaches or suggests the compositions of the present invention that may be used to make insulating foams possessing advantageous properties that additionally are “green” or environmentally friendly.

### SUMMARY OF THE INVENTION

This invention relates to the compounding and formulating of specific ingredients that, when mixed together in precise proportions may be used to produce foam-in-place insulating foams with improved insulating values, increased fire resistance and the formation of a non-combustible rigid ceramic matrix after combustion of the foam. In addition, the foam insulation compositions may be labeled as environmentally friendly “green” building materials and components.

The formulations used to create these foams are comprised of a poly-isocyanate, a polyol having a hydroxyl number of greater than about 200, cenospheres; a water soluble alkali metal silicate, a blowing agent and a catalyst. Preferably, these foams are comprised of a cyanide-free poly-isocyanate, a polyol, preferably a vegetable oil based polyol, cenospheres derived from coal combustion ash waste, aqueous solution of sodium silicate and a catalyst. The polyol may be petroleum based or vegetable oil based and may or may not contain post-industrial or post-consumer recycled polymers. The subject formulations are advantageous in that they utilize otherwise discarded waste products, resulting from coal combustion in energy generating production plants, to make insulating, fire retardant products that are energy efficient and safe to use, and particularly safe in the event of exposure to fire.

### BRIEF DESCRIPTION OF THE FIGURE

FIG. 1 is a view of a mixing head with spiral and transverse groves.

### DETAILED DESCRIPTION OF THE INVENTION

The present invention provides foam insulation products that have excellent insulative properties and after being exposed to fire maintain a rigid structure, retain insulating properties and preferably are “green” in nature in addition to being energy efficient, non-toxic and fire resistant. The enhanced properties are achieved though the use of coal combustion waste by-products, a water soluble alkali metal silicate bonding agent and a polyol. The polyol is preferably derived from vegetable oils and post-industrial or post-consumer recycled polymers. The subject formulations comprise a poly-isocyanate chemical available from a number of major chemical processors; a polyol which may be synthetic petroleum based or, preferably vegetable oil based and which may or may not contain post-industrial or post-consumer recycled polymers, preferably polyesters; cenospheres, a by-product of coal combustion waste and a water solution of a water soluble alkali metal silicate. When exposed to fire sufficient to burn off the organic foam components, a non-combustible rigid ceramic structure remains. The structure occupies the same space as the original foam insulation.

Insulating foam material prepared in accordance with the subject invention may qualify for LEED (Leadership in Energy and Environmental Design) certification.

To make foam, the polyurethane polymer must be expanded or blown by gas or a gas-forming material. There are two different preferred ways to produce gas during the polyurethane foaming process. One is called physical gas-production reaction process and the other is called chemical gas-production reaction process. In physical gas-production reaction, the gases are produced by vaporizing the blowing agent which is a low-boiling non-reactive liquid in the foam formulation such as chlorofluorocarbons (CFC) and hydrofluorocarbons (HFC), such as CFC-n, CFC-22, HFC-245fa, pentane, and methyl formate, with heat generated from the polymerization reaction. Due to environmental issues, the CFC and HFC gases are no longer used and due to health and safety issues, the hydrocarbon blowing agents are not considered suitable for polyurethane foaming. The other, more preferred, method of generating gas during the foaming process is called chemical gas-production process. For example, carbon dioxide is produced from the reaction of an isocyanate group with water. The intermediate product of this reaction is a thermally unstable carbamic acid, which spontaneously decomposes to an amine and carbon dioxide.

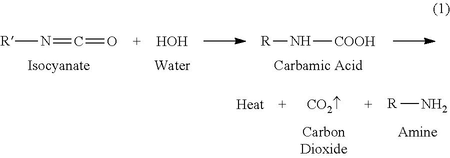

### Poly-Isocyanates

Representative examples of useful poly-isocyanates include those having an average of at least about 2.0 isocyanate groups per molecule. Both aliphatic and aromatic polyisocyanates can be used. Examples of suitable aliphatic polyisocyanates include 1,4-tetramethylene diisocyanate, 1,6-hexamethylene diisocyanate, 1,12-dodecane diisocyanate, cyclobutane-1,3-diisocyanate, cyclohexane-1,3- and 1,4-diisocyanate, 1,5-diisocyanato-3,3,5-trimethylcyclohexane, hydrogenated 2,4-and/or 4,4′-diphenylmethane diisocyanate (H.sub.12MDI), isophorone diisocyanate, and the like. Examples of suitable aromatic polyisocyanates include 2,4-toluene diisocyanate (TDI), 2,6-toluene diisocyanate (TDI), and blends thereof, 1,3- and 1,4-phenylene diisocyanate, 4,4′-diphenylmethane diisocyanate (including mixtures thereof with minor quantities of the 2,4′-isomer) (MDI), 1,5-naphthylene diisocyanate, triphenylmethane-4,4′,4″-triisocyanate, polyphenylpolymethylene polyisocyanates (PMDI), and the like. Derivatives and prepolymers of the foregoing polyisocyanates, such as those containing urethane, carbodiimide, allophanate, isocyanurate, acylated urea, biuret, ester, and similar groups, may be used as well.

The amount of polyisocyanate is present in the stoichiometric equivalent amount required react with the polyol and any other reactive additives, preferably is present in an amount sufficient to provide an isocyanate index of about 90 to about 120, preferably about 100 to about 110, and, in the case of high water formulations (i.e., formulations containing at least about 5 parts by weight water per 100 parts by weight of other active hydrogen-containing materials in the formulation), from about 100 to about 115. As used herein the term “isocyanate index” refers to a measure of the stoichiometric balance between the equivalents of isocyanate used to the total equivalents of water, polyols and other reactants. An index of 100 means enough isocyanate is provided to react with all compounds containing active hydrogen atoms.

A preferred poly-isocyanate is cyanide free. The preferred poly-isocyanate reactants of the formulations of the present invention are an MDI (methylene diphenylene diisocyanate, diphenylmethane diisocyanate or diisocyanatodiphenylmethane). These are mixtures of MDI (mainly 4,4′-diisocyanato-diphenylmethane with an isomeric 2,4′-diisocyanato-diphenylmethane content) and higher molecular components. As a molecular unit is repeated in the structure of these higher molecular components, the isocyanate mix is also called polymeric MDI (PMDI) or MDI polymer.

While MDI has two NCO groups, the higher molecular PMDI-components contain three and more NCO groups. MDI and PMDI are therefore known as poly-isocyanates. The average functionalities of the conventional PMDI types are about 2.5 to 3.2. PMDI prepolymers should be mentioned although they only play a small part in the production of rigid polyurethane foams. The PMDI involved is one in which some of the NCO groups have been made to react by the addition of polyol. Compared to the starting PMDI, the NCO content is therefore lower and the viscosity significantly higher. With the aid of prepolymers, problems can be averted and certain effects achieved. For example, the quantity of heat released during production of the foam is reduced and the compatibility of polyisocyanate with the polyol and the structure of the resultant macromolecule are influenced. Isocyanates based on MDI for the production of rigid polyurethane foams are viscous liquids that are brownish to dark brown in color.

The polyol component of the formulations may be petroleum based or based on vegetable oils. Polyether polyols and polyester polyols are two major kinds of petroleum based polyols suitable in the present invention. The preferred vegetable based polyols are based on soybean oil. Soy based polyols are viscous liquids that react extremely well with isocyanate groups of the poly-isocyanate. The characteristic chemical feature of the polyol, poly-isocyanate reaction is the reactivity of the hydrogen bonded to the oxygen of the hydroxyl group. A distinction is made between soy-based polyether and polyester polyols. Polyether polyols are produced by reacting polyhydric alcohols, for example glycols, glycerol or cane sugar, or oramines such as ethylene diamine, with alkyleneoxides, and rigid foam polyols are mainly produced by reaction thereof with propylene oxide. Hydroxylated vegetable oils such as castor, linseed, soybean, tall oil and the like are useful in the present invention.

Polyester polyols fall into two distinct categories according to composition and application. Conventional polyester polyols are based on virgin raw materials and are manufactured by the direct polyesterification of high-purity diacids and glycols, such as adipic acid and 1,4-butanediol. They are distinguished by the choice of monomers, molecular weight, and degree of branching. While costly and difficult to handle because of their high viscosity, they offer physical properties not obtainable with polyether polyols, including superior solvent, abrasion, and cut resistance. Other polyester polyols are based on reclaimed raw materials. They are manufactured by transesterification (glycolysis) of recycled poly(ethyleneterephthalate) (PET) or dimethylterephthalate (DMT) distillation bottoms with glycols such as diethylene glycol. These low molecular weight, aromatic polyester polyols are used in the manufacture of rigid foam, and bring low cost and excellent flammability characteristics.

A preferred polyol of the present invention is hydroxylated soy oil based or reclaimed polyester or mixtures thereof. Polyols suitable in the present invention are described in US 2009/0292099; U.S. Pat. No. 5,266,714; U.S. Pat. No. 5,302,626 which are incorporated here in their entirety.

The reactivity of a given polyol is influenced by the hydroxyl number found per molecule. If the polyol is a mixture of components with different functionalities, the average functionality is given. Parts of the molecule that can undergo reactions, such as, for example, the hydroxyl groups, are called functional groups. A measure of the hydroxyl group content is called the hydroxyl or OH-value. To select the correct polyol for each formulation, the hydroxyl number (hydroxyl (OH)-value, mg KOH/g), viscosity and water content must be determined.

The polyol of the present invention will have a hydroxyl number of about 200 or greater. Preferably the hydroxyl number will be about 200 to about 800, more preferable the hydroxyl number will be about 200 to about 600 and most preferably the hydroxyl number will be about 200 to about 400. The polyol is present in an amount from about 20% to about 70% by weight of the composition. Preferably the polyol is present in an amount about 40% to about 65% and more preferably from about 50% to about 60% by weight of the composition.

The fire-resistant solid filler incorporated in the poly foam formulations of the invention are microspheres. The preferred microspheres are glass microspheres and cenospheres. Glass microspheres are hollow glass spheres such as those sold by ₃M as “Glass Bubbles” and Cospheric LLC. Glass microspheres useable in the present invention are described in U.S. Pat. No. 3,030,215; U.S. Pat. No. 3,365,315; U.S. Pat. No. 4,661,137 and US 2010/0040881. Cenospheres are derived from coal combustion by-products. Cenospheres are hollow glass bubbles which are formed in pulverized coal fired boilers at temperatures often exceeding 1300 C. Cenospheres are formed during a stage when the coal being burned is fully converted into a molten gaseous state. While in the molten state, this gaseous material begins to form into a spherical shape as cooling beings to occur. The spherical shape is a naturally occurring structure due to the fact that it provides for the lowest surface tension while the gaseous material cools and falls from the top of the boiler to its lower sections where all coal combustion by-products are collected for disposal. The resulting glass bubbles are collected and packaged through a variety of means including floatation. Once separated from the other coal combustion by-products cenospheres are packaged and sold to multiple industries and for multiple applications. Glass spheres and cenospheres of the present invention have a bulk density of less than about 1 gm/cm³ and have a mean diameter from about 5μ to about 800μ, preferably from about 50μ to about 500μ and more preferably from about 50μ to about 300μ. The upper limit on the microsphere diameter useful in the present invention is about 2000μ and the lower limit is about 1μ.

The fourth major component of the subject formulations is a water soluble alkali metal silicate dissolved in water that is added to the formulation during mixing. The water soluble alkali metal silicate is selected from the group consisting of lithium silicate, sodium silicate, potassium silicate.

This compound is commonly used in other applications as a fire-resistant additive. The preferred alkali metal silicate is sodium silicate. For example, sodium silicate liquids are manufactured by dissolving sodium silicate white powder in water thereby producing an alkaline solution. Sodium silicate is stable in neutral and alkaline solutions. In acidic solutions, the silicate ion reacts with hydrogen ions to form silicic acid that, when heated, forms a hard glassy silica gel. Preferably, the subject compositions contain a small amount of this sodium silicate solution, generally from about 0.1% to about 20% by weight, based on the total weight of the formulation. Preferably the soluble alkali metal silicate is prepared in a water solution wherein the soluble silicate is about 40% by weight of the final aqueous solution. The concentration of soluble alkali metal silicate in water can vary from about ₅% to about 70% by weight. Preferably from about 10% to about 60% an most preferably from about 30% to about 55% on a weight percent basis of soluble alkali metal silicate to the total weight of the aqueous solution. The aqueous solution is preferred to be present in the formulation from about 0.5% to about 15%, preferably from about 0.5% to about 10%, and more preferably from about 02.5% to about 10% and most preferably from about 3.5% to about 8.5% by weight of the formulation. The preferred soluble alkali metal silicate is sodium silicate.

The aqueous solution of alkali metal silicate serves two functions in the present formulation. First, it contains the silicate component of the formulation. Second, the aqueous solution of alkali metal silicate provides the blowing agent, water, to the formulation. The amount of alkali metal silicate dissolved in water useful in the present invention will vary as indicated above. This adjustment of concentration of silicate in water will facilitate controlling the amount of blowing agent added to the formulation when more or less gas formation is desired for a particular application of the foam. This also allows for adjusting the amount of silicate being added to the formulation to increase fire retardant ability of the foam or bonding strength of the silicate with the cenospheres. Additionally, the resulting poly foam, once cured, has enhanced fire-resistance capabilities as a result of the silica gel which is created when the foam is exposed to temperatures created during the chemical reaction described above that produces carbon dioxide.

It is believed, without being held to a particular theory of operation, that the carbamic acid, heat and the carbon dioxide produced during the blowing reaction are in part responsible for the observed property of the inventive foams to form ceramic matrices when the organic polyurethane is burned out of the foam. It is believed that upon heating in the presence of the carbamic acid and carbon dioxide produced during the blowing reaction, the alkali metal silicate species begin crosslinking to form polymers. Alkali metal silicate is believed to undergo gelation/polymerization reactions when the pH drops below about 10.7. Further, silicates are believed to play a role in agglomeration of particulates in the presence of acid and high carbon dioxide concentrations. As the blowing reaction continues, it is believed that the carbamic acid and high carbon dioxide content produced by the blowing reaction cause the silicate to form bonds with and agglomerate the cenospheres. This internal foam structure acts as a foam stabilizing agent thus strengthening the hot foam and in conjunction with the rapid cure times of the present invention prevents the foam from collapsing as it cools. Upon intense heating, as during a fire, the silicate dehydrates as the foam is burned off thereby forming a strong ceramic bond between the cenospheres and silicate. It is this sequence of reactions that produce the after fire, strong ceramic matrix having the same shape and dimensions of the original foam. The insulative material of the present invention provides heat insulation and physical strength to foam filled insulated panels before a fire, during a fire and after a fire.

Blowing Agents

The Blowing agents necessary to create the subject polyfoams are water or water from the aqueous sodium silicate solution. As previously mentioned, the reaction of isocyanate and blowing agent yields carbon dioxide which acts as a blowing agent during the exothermic chemical reaction. This is referred to as a chemical blowing process.

The blowing agent generates a gas under the conditions of the reaction between the active hydrogen compound and the polyisocyanate. Suitable blowing agents include water, acetone, methylene chloride, and pentane, with water being preferred.

The blowing agent is used in an amount sufficient to provide the desired foam density and Indention Force Deflection rating (IFD). For example, when water is used as the only blowing agent, from about 0.5 to about 10, preferably from about 1 to about 8, more preferably from about 2 to about 6 parts by weight, are used per 100 parts by weight of other active hydrogen-containing materials in the formulation.

Water is the primary blowing agent used, but it can be supplemented with volatile organic blowing agents.

The subject formulation may also contain activators to aid in the formulation of the polyols and poly-isocyanates and also for the reaction of isocyanate with water. The activators (also termed catalysts) added to the reaction mix are typically tertiary amines, organo-tin compounds or alkali salts of aliphatic carboxylic acids that particularly promote isocyanurate formation. The most common activators utilized are triethylamine, dimethylcyclohexylamine, dibutyltin dilaurate and potassium acetate. Some individual compounds present in the activators have unique effects on the reactions described. Catalysts are commercially available from Air Products Company under the tradenames of Polycat. and Dabco and from Tosoh corporation under the tradename TOYOCAT® specialty amine catalysts for polyurethanes. The following non-limiting list of catalysts are useful in the present invention Polycat 8®, Polycat 5®, Dabo® and Toyocat®. One skilled in the art will be aware of additional catalysts useful in the present invention.

Optionally, foam stabilizers may also be incorporated in the inventive poly foam formulation. Organo-silicon compounds, for example, polyether polysiloxanes, that have a surface-active effect, are used as foam stabilizers, and emulsifiers. Foam stabilizers can be used to control the inner foam structure, the open- and closed-cell character and the cell size of the foam and, therefore, have a substantial influence on the foams final properties.

### Other Additives

Other additives that may be included in the inventive formulation include surfactants, catalysts, cell size control agents, cell opening agents, colorants, antioxidants, preservatives, static dissipative agents, plasticizers, crosslinking agents, flame retardants, and the like.

Polyurethanes are organic compounds and, as such, are by nature flammable. In order to delay the ignition process, chemical additives and flame retarding components can be incorporated. The incorporation of aromatic polyester polyols can assist in improving the fire resistance of the foam. The use of halogen-containing polyols can also be helpful. Additionally, non-reactive additives, such as trialkyl, trishalogen alkyl and triaryl phosphates may be incorporated into the formulation. Triethyl phosphate, tris-chloroisopropyl phosphate and diphenylcresyl phosphate can likewise be useful. Solid, flame resistant fillers such as the materials incorporated in the subject foams offer the most beneficial fire-resistance. Typically, these type of fire retardant has been scarcely used as they have been difficult to incorporate into the foam from a process standpoint. The foams of the subject invention are advantageous in that they allow for the addition of these retardants thereby adding to the flame retardant character of the present invention.

Through testing it has been determined that the performance of the subject poly foam formulations can be significantly modified through formulation percentage modifications. Utilizing varying percentages of the base raw materials: the polyol, isocyante, solid filler, and aqueous sodium silicate can provide poly foams with tailored physical characteristics and performance. The subject formulations contain between about 20% and 70% by weight of the polyol, between about 20% and 70% by weight of the poly-isocyanate wherein the poly-isocyanate is present in the stoichiometric equivalent amount required react with the polyol and any other reactive additives. The fire resistant foam insulation wherein the poly-isocyanate is present from about 90 percent to about 120 percent of the stoichiometric equivalent amount required react with the polyol and any other reactive additives. The fire resistant foam insulation contains between about 10% and about 60% by weight of the solid cenosphere filler and between about 0.01% and 20% by weight of aqueous alkali metal silicate solution. In general, experience has shown that the higher the polyol percentage the less rigid the resulting poly foam. In contrast, the higher the isocyante percentage, the more rigid the poly foam becomes. Fire and heat resistance is increased as the percentage of solid filler and aqueous sodium silicate are increased.

Foam-in-place insulation applications require that the reactive components be mixed together at the last possible moment before depositing the formulation into the end product to be insulated because, once mixed together, the chemical reaction and foaming process begin, typically in less than about 60 seconds. Polyurethane or poly-isocyanurate foams are often two-part liquid systems wherein the liquids are mixed under high pressure in a simple mixing manifold. Such devices are commercially available and known to those skilled in the art. Standard commercial polyurethane processing equipment may be used for the foam forming process. An example of such a machine would be ES 125A Easy spray PU foam & Polyurethane 2K machine available from Injection Tech International Ltd. Such devices are commercially available from DESMA TEC and Linden Industries Inc. as well as other companies. The addition of additional chemicals and particularly the addition of a dry component coupled with controlling the start time of the reaction require special handling.

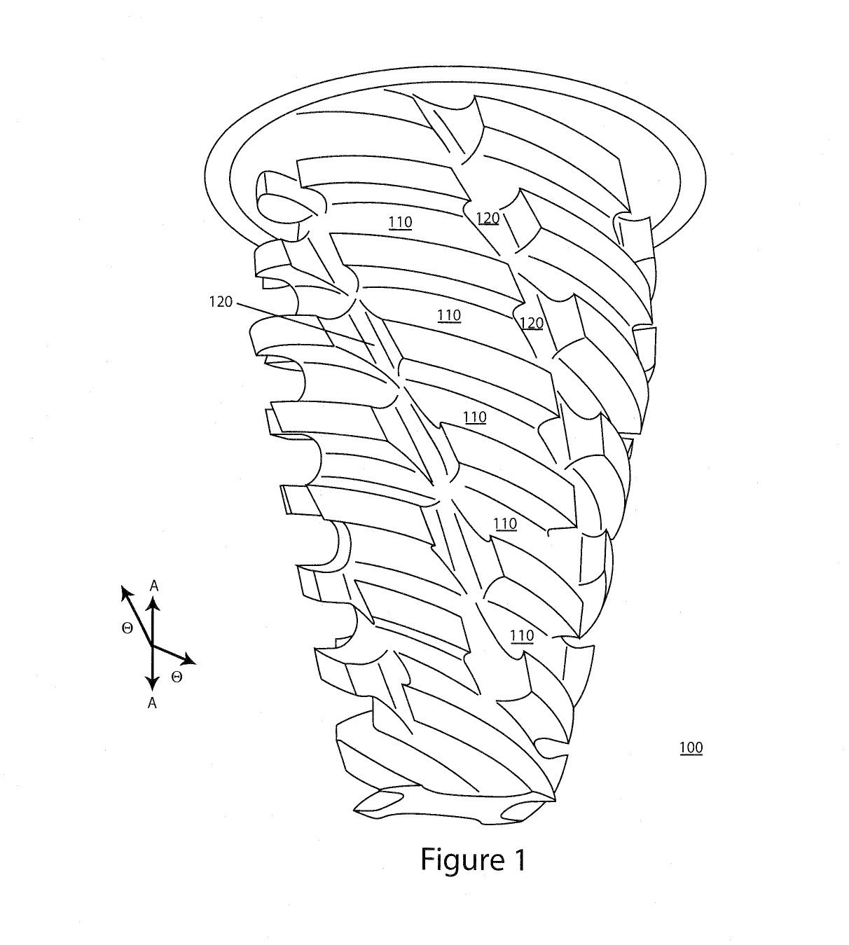

In preparing the subject compositions, adding the dry filler may take place by either of two methods. In the first, the cenosphere product is pre-mixed with the polyol liquid in a separate mixing tank. The resultant “paste” is then pumped to a customized off-the-shelf mixing head, FIG. 1, where it is combined with the isocyanate liquid and aqueous sodium silicate which is also pumped directly to the mixing head. The preferred mixing head for the present invention has the capability of combining 3 components in the mixing head. The pumps are precisely programmed through a bank of programmable controllers which open and close valves on demand to deliver precise volumes of each component to the mixing head. Off the shelf mixing heads for mixing viscous materials are commercially available from DESMA Tec, Linden Industries Inc. and others.

FIG. 1 depicts mixing head 100 in accordance with an embodiment of the invention. Mixing head 100 is located within a mixing head assembly where the constituent components of the foam is provided from the mixing container at metered quantities. Mixing head 100 can be formed from aluminum, ceramic, steel, stainless steel or any hard material and/or alloy that is, or can be, resistant to corrosion. In one implementation, corrosive protection can be added to the mixing head—e.g., anodized or polytetrafluoroethylene coated aluminum, chrome plated steel, etc. In accordance with an embodiment of the invention, mixing head 100 can be frusto-conical in shape. In other implementations the mixing head can be conical, pyramidal, cylindrical, etc. Spiral grooves 110 incused in the surface of mixing head 100 direct the flow of the composite mixture from an end of mixing head 100 proximal to the mixing container to a distal end of the mixing head. Spiral grooves no are positioned at angle Θ, which is generally acute to a longitudinal axis of the mixing head (shown by arrows A-A). Transverse grooves 120 are incused into the surface of the mixing head and positioned at angle Φ, which is generally obtuse to the longitudinal axis of mixing head 100. Transverse grooves 120 direct the flow of the composite mixture towards the distal end of the mixing head and, in conjunction with spiral grooves 110, prevent the composite mixture from jamming the mixing head. A preferred mixing head useful in the present invention is a KYMOFOAM KF Series 200. Larger models such as the 700 and 1500 are preferred for larger volumes.

In a second method of preparing the composition, the three liquids are pumped to the mixing head in the same controlled manner, but the cenosphere product is dosed into the mix dry, directly on the mixing head via a dosing feed system added to the standard mixing head. In either instance, a homogeneous mix is achieved on a continuous basis.

In calculating the formulation for the poly foam a prescribed the proportion of polyol, isocyanate, solid filler, and aqueous sodium silicate catalyst are calculated with regard to the hydroxyl number (OH value) of the polyol, the water content and the isocyanate content (NCO). The calculated formulation must ensure that an NCO group of the isocyanate is available to react with each OH group of the polyol.

If the polyol component already contains the catalyst(s) and additives required for foaming, it is preferable to raise the polyol temperature, as with the isocyanate, to a temperature of about 85° F. to about 105° F. In most cases, the polyol component is supplied without an activator or blowing agent. Both additives then are added to the polyol with mixing after the polyol is brought to a temperature of about 85° F. to about 105° F. The blowing agent is also been brought to about the same temperature in advance. A temperature of about 85° F. to about 105° F. is preferred to ensure a consistent reaction and foaming process. If flame retardants, water, stabilizers, blowing agents and the like are added to the polyol, the polyol should be continuously and thoroughly mixed to avoid separation of the components before combining with the poly-isocyanate. Mixing the additives into the polyol is more efficient when the polyol is heated as this reduces the viscosity of the polyol. Heating the poly-isocyante to a temperature of about 85° F. to about 105° F. when adding additives such as cenospheres is preferred. Preferably, the polyol additive mixture is prepared shortly before combining with the poly-isocyanate. The term “shortly” in this context is about 2 hours or less. This will avoid possible segregation of the components of the mixture which may occur if the mixed polyol and additives is stored for more than about 2 hours before use.

For foam production, the prepared raw materials, i.e. the polyol component, isocyanate component, and solid filler, including additives as discussed above, which have been brought to a temperature of about 85° F. to about 105° F. are thoroughly mixed together. The exothermic reaction starts after a short period of time and begins to generate heat. Temperatures within the core of this reaction mix can reach 180° C. and beyond as the reaction progresses. The reaction temperature is dependent on the specific formulation and the total amount by weight of reaction mix. During this reaction, the heat generated helps to evaporate volatile liquids, i.e. blowing agents present in the formulation. The release of these gases causes the formulation to expand and form the foam. During this expansion process, the water in the sodium silicate solution reacts with the isocyanate to form polyurea and carbon dioxide, which then enhances the expansion of the foam. The reaction mixture continually expands, aided by blowing gases released, until the reaction product reaches the solid state as a result of progressive crosslinking. Once this crosslinking has ended, the foam is complete.

The reaction and foaming process progresses through the following stages:
(1) Mixing and stirring—all components are combined and thoroughly blended;
(2) Creaming and foaming—the reactants visibly start foaming in the mix, often accompanied by a change in the color of the formulation often developing a cream color;
(3) String or fiber formation—transition of the formulation from a liquid to the solid. It roughly corresponds to the gel point of the resin. The reaction is roughly 50% complete when this stage is reached. The onset of this stage may be measured by placing a wooden rod into the formulation repeatedly, and determining when the rod draws fibers. The time for this measurement begins with mixing;
(4) Full rise and tack-free—After the fiber stage is complete, the speed at which the foam rises begins to slow. The time from the start of mixing till the end of the optically perceptible rise is called the rise time. The surface of the foam is still tacky when the rise process is complete. By repeatedly testing the foam surface with a wooden rod, the moment it is free from being tacky this stage is considered to be complete and the foam is tack-free. The time elapsing from the start of mixing to the moment when the surface is no longer tacky is called tack-free time.

The reaction times are dependent on the temperature of the reaction mixture and varies inversely with rise and fall of the reaction temperature. The fiber time gives the surest and most accurate information on reactivity, which is why it is used almost exclusively for establishing the reaction rate. Comparative data on reactivity constantly have to refer to identical temperatures of the starting materials.

The percentage of the aqueous sodium silicate used has a direct effect on the start of the chemical reaction once all ingredients are thoroughly mixed. This component may be critical to individual end users dependent on their production system and whether it is fully or semi-automated in design. Preferably, the sodium silicate solution added should not exceed about 8 percent by weight of the total composition. Sodium silicate solution in excess of about 8 percent by weight of the total composition will reduce the growth of the foam.

The polyurethane foams produced in accordance with the subject invention have a variety of advantages that make their use attractive to the end user. Among these advantages, the foams can be produced in a wide range of densities, they adhere well to a variety of laminates and facings without the use of any additional adhesives, and they can easily be injected into cavities. The foams are applicable to foam-in-place applications in construction component manufacturing such as commercial and residential overhead doors, pass through doors, windows and construction panels.

It is particularly advantageous to the user that the foams of the present invention when made with vegetable based polyols and cyanide free poly-isocyanate are considered “green”, have a high insulating value, emit minimal, non-toxic smoke when exposed to direct flame and are essentially self-extinguishing leave a ceramic insulative residual in the insulated product after a fire.

### EXAMPLE 1

### Formation of Polyurethane Foam

60 grams of Honey Bee HB 230 (soy based polyol having a hydroxyl number of 220-240 mg KOH/gm) is mixed with 60 grams of cenospheres having diameters of about 50μ to about 300μ in a 100 ml beaker. Sixty (60) grams of Methyl di-p-phenylene isocyanate (MDI) (Lupranate® M20 Series (BASF) no-added formaldehyde) is then added to the mix with continued mixing. Six (6) grams of Sodium silicate solution, 40 wt. % sodium silicate in water, is then added with mixing. Once all the ingredients have been added, mixing is continued for at least about 10 seconds. At that point, the foaming and polyurethane formation reaction has begun. The formulation begins to change color and generate heat. After an additional about 10 seconds, the foam begins to expand. By the 30th second the formulation is expanding rapidly due to the formation of foam. At about the 45th second the formulation expansion rate begins to slow and material begins to harden. At about the 50th second the urethane foam is now formed and can be handled. The method of manufacture of Honey Bee 230 and related commercially available soy based polyols is described in U.S. Patent Publication No. 2009/0292099 having U.S. Ser. No. 12/462,024 which is incorporated herein by reference in its entirety.

Test panels were prepared using the inventive formulation of Example 1. The panels were tested by ASTM C 518 (ASTM C 518, “Standard Test Method for Steady-State Heat Flux Measurements and Thermal Transmission Properties by Means of the Heat Flow Meter Apparatus;”) to determine R values. And by ASTM E413: Classification for Rating Sound Insulation Test Method E90—The single-number rating is called sound transmission class (STC).

### EXAMPLE 1A

### Test Panel of Inventive Polyurethane Foam

The polyurethane formulation of Example 1 was prepared and after addition and mixing of the sodium silicate solution the immediately poured into a 12 inch by 12 inch by 1 inch thick wooden frame. The frame 12″×12″×1″ (much like a picture frame) was made. Then 2 thin metal plates 12″×12″ were wrapped in non stick film and placed against both sides of the frame. (a sandwich) Then one side of the frame was removed to allow access to the inner volume. The mixture was poured into the frame. Immediately after pouring the mixture into the frame cavity, the side of the frame which had been removed was closed again. The wooden frame was laid on its side inside a press where the frame was held tight so that the expanding foam would not cause the thin metal plates to be pushed away from the frame as the polyurethane foam expanded. The foam was cured within about 60 to about 75 seconds. The pressure from the press was released and the frame was opened, leaving behind a 12×12×1 inch foam panel.

### EXAMPLE 1B & 1C

### Test Panels of Inventive Polyurethane Foam were Made as Described in Example 1A

| | | | | Sound |
|---|---|---|---|---|
| | | | | Transmission |
| | Description | R-Value | | Class |
| Sample 1 | Thickness inches | Total | R/inch | (STC) |
| A | 0.94 | 5.8 | 6.2 | 34 |
| B | 1.12 | 7.1 | 6.3 | 38 |
| C | 0.94 | 5.9 | 6.3 | 37 |

The test results illustrate the high thermal insulation properties and the high sound insulation properties of the inventive foam.

It is to be understood that while certain forms of the present invention have been described herein, it is not to be limited to the specific forms or arrangement as described and shown.

What is claimed is:

1. A fire resistant foam insulation composition comprising:
a poly-isocyanate;
a polyol;
microspheres;
a blowing agent; and
a catalyst.

2. The fire resistant foam insulation of claim 1 wherein the poly-isocyanate is cyanide free.

3. The fire resistant foam insulation of claim 1 wherein the microspheres are selected from the group consisting of glass microspheres and cenospheres.

4. The fire resistant foam insulation of claim 1 wherein the polyol has a hydroxyl number of about 200 to about 800.

5. The fire resistant foam insulation of claim 1 wherein the polyol has a hydroxyl number of about 200 to about 800.

6. The fire resistant foam insulation of claim 1 wherein the polyol has a hydroxide number from about 200 to about 600.

7. The fire resistant foam insulation of claim 1 wherein the polyol has a hydroxide number from about 200 to about 400.

8. The fire resistant foam insulation of claim 1 wherein the polyol has a hydroxide number from about 200 to about 350.

9. The fire resistant foam insulation of claim 1 wherein the polyol is present in an amount from about 20% to about 70% by weight of the composition.

10. The fire resistant foam insulation of claim 1 wherein the polyol is present in an amount from about 40% to about 65% by weight of the composition.

11. The fire resistant foam insulation of claim 1 wherein the polyol is present in an amount from about 50% to about 60% by weight of the composition.

12. The fire resistant foam insulation of claim 1 wherein the polyol is soy oil based polyol.

13. The fire resistant foam insulation of claim 1 wherein the polyol is a vegetable oil based polyol.

14. The fire resistant foam insulation of claim 1 wherein the polyol is a polyester.

15. The fire resistant foam insulation of claim 1 wherein the cenospheres have a mean diameter of about 5μ to about 800μ.

16. The fire resistant foam insulation of claim 1 wherein the cenospheres are present from about 5 percent to about 70 percent by weight of the composition.

17. The fire resistant foam insulation of claim 1 wherein the cenospheres are present from about 10 percent to about 70 percent by weight of the composition.

18. The fire resistant foam insulation of claim 1 wherein the cenospheres are present from about 20 percent to about 55 percent by weight of the composition.

19. The fire resistant foam insulation of claim 1 wherein the water soluble alkali metal silicate is selected from the group consisting of lithium silicate, sodium silicate, potassium silicate.

20. The fire resistant foam insulation of claim 1 wherein the water soluble metal silicate is present in an amount from about 0.5 percent to about 10 percent by weight of the composition.

21. The fire resistant foam insulation of claim 1 wherein the blowing agent is water.

22. The fire resistant foam insulation of claim 1 wherein the blowing agent is present in an amount of about 1 percent to about 5 percent by weight of the composition.

23. The fire resistant foam insulation of claim 1 wherein the poly-isocyanate is present in the stoichiometric equivalent amount required react with the polyol and any other reactive additives.

24. The fire resistant foam insulation of claim 1 wherein the poly-isocyanate is present from about 90 percent to about 120 percent of the stoichiometric equivalent amount required react with the polyol and any other reactive additives.

25. The fire resistant foam insulation of claim 1 wherein the catalyst is a tertiary amine.

26. The fire resistant foam insulation of claim 1 wherein the catalyst is selected from the group consisting of Polycat 8®, Polycat 5®, Dabo and Toyocat®.

27. The fire resistant foam insulation of claim 1 wherein the catalyst is present in an amount from about 0.01 percent to about _{0.3} percent by weight of the composition.
